(19) United States
(12) Patent Application Publication
(10) Pub. No.: US 2003/0206337 A1
(43) Pub. Date: Nov. 6, 2003

(54) Exposure apparatus for irradiating a sensitized substrate

(75) Inventors: Rongguang Liang, Rochester, NY (US); David Kessler, Rochester, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/139,489

(22) Filed: May 6, 2002

(51) Int. Cl. F21V 9/14

(52) U.S. Cl. 359/352; 359/355; 359/483; 359/485; 359/487; 362/19

(57) ABSTRACT

An exposure apparatus (10) for applying high-intensity, uniform polarized UV irradiation to a sensitized substrate such as an LCD alignment layer. A telecentric projection system (20) projects a uniformized light towards a surface (28) for irradiation. One or more individual light sources (12) can be combined to provide the intensity needed over the area of the surface (28). An integrator (40) with combining structures (42) allows combination of light from multiple light sources (12). A polarizer (18) is provided at one of an alternate number of locations in the exposure illumination path.

### FIELD OF THE INVENTION

This invention generally relates to apparatus for applying exposure energy onto a sensitized substrate and more particularly relates to an exposure apparatus for irradiating a sensitized substrate with uniform polarized high-intensity UV light.

### BACKGROUND OF THE INVENTION

Conventional methods for irradiating a photosensitive substrate range from curing processes to microlithography. Recently, polarized ultraviolet (UV) light irradiation has been shown to have advantages for efficient preparation of the alignment layer in fabrication of liquid crystal displays (LCDs). This method is now widely used as an alternative to conventional rubbing methods for treatment of the alignment layer. For example:

U.S. Pat. Nos. 6,307,609 and 6,061,138 disclose a polarized light exposure system that employs a louvered arrangement to obtain partial polarization and partial collimation of the light radiation applied to a surface.

U.S. Pat. No. 5,934,780 discloses a polarized light exposure device for UV irradiation using conventional Brewster's angle polarizers.

U.S. Pat. No. 6,190,016 discloses a polarized light exposure device for UV irradiation that employs a smaller polarization component that may be a Brewster's angle polarizer or similar device. Similarly, EP 1 020 739 A2 and EP 1 172 684 disclose devices using alternative V-shaped Brewster's angle arrangements.

U.S. Pat. No. 6,300,991 discloses a particular type of photo-alignment material and irradiation method for alignment.

Patent No. WO 00/46634 discloses a method for photo-alignment using a unpolarized or circularly polarized source, applied in oblique direction.

U.S. Pat. No. 5,389,698 discloses the use of linearly polarized UV light for photopolymer irradiation.

U.S. Pat. No. 6,292,296 discloses using a large scale polarizer of quartz segments disposed at Brewster's angle, used for system that irradiates using UV light.

U.S. Pat. No. 5,604,615 and EP 0 684 500 A2 disclose forming an alignment layer by directing collimated UV through slits in a photomask.

U.S. Pat. No. 6,295,110 (Ohe et al.) discloses irradiation of an LCD alignment surface with a polarized laser source.

While the patents listed above have shown some workable devices and techniques for alignment using UV light, there remains room for improvement. Particular problems that relate to devices for alignment layer preparation include the following:

(1) Significant light intensity is required. This is important for efficient processing and speed. High intensity exposure energy can be achieved in a number of ways, such as by using multiple light sources. However, multiple light sources must be combined in a manner that also satisfies requirements for uniformity, as described below.

(2) A relatively large area must be irradiated. In contrast to microlithography apparatus, which typically irradiates a surface of no more than a few square inches at a time, an apparatus for alignment layer processing must irradiate a sizable surface area, 30 inches on a side or larger, for example. Since exposure energy is a factor of both intensity and area, it is recognized that increasing the area magnifies the intensity demands.

(3) Uniform exposure energy must be applied across a surface. This requirement becomes more difficult to meet as surface area increases.

(4) A uniform illumination angle is needed. This also becomes more difficult with an increase in surface area.

In addition, it can be appreciated that an ideal solution would minimize cost and minimize the need for highly specialized lighting components.

Polarized UV light provides an optimal light source for alignment layer irradiation. For preparation of alignment layers, processing is typically done in two stages. In a first stage, the alignment substrate is exposed to polarized UV light at a first angle for a set period of time. Then, in a second stage, UV light having a polarization rotated 90 degrees with respect to the first angle is applied.

Some of the well known shortcomings of existing systems for UV irradiation relate to polarization methods. High heat requirements obviate use of conventional polarizing components that operate by absorption. However, polarization solutions for conventional UV irradiation apparatus fall short of providing uniformity at low cost. For example, the polarizer disclosed in U.S. Pat. No. 6,292,296, disposed above the substrate surface, is very large and is costly to produce. Similarly, the approach disclosed in U.S. Pat. No. 5,934,780, with large Brewster plates disposed in the path of an exposure beam, would be unwieldy and expensive, requiring the added cost and complexity of collimating optics, as is disclosed in that patent. The Brewster plates approach disclosed in U.S. Pat. No. 6,307,609 would be difficult and costly to implement for alignment over a large surface area. The alternate approach for using Brewster plate polarization disclosed in U.S. Pat. No. 6,190,016, with Brewster plates disposed ahead of an integrator and shutter, would not provide the needed uniformity, since light incident to the polarizer is at various angles across the field. The alternate V-shaped Brewster plate arrangements of EP 1 020 739 A2 and EP 1 172 684 do not provide the necessary uniformity across the field. In some orientations, these V-shaped configurations are known to exhibit shadows.

Conventional equipment for UV irradiation, particularly in microlithography, use collimated or substantially collimated UV light. For example, fine-line UV exposure systems such as those manufactured by Tamarack Scientific Co., Inc., Corona, Calif., use collimating reflectors to direct collimated light onto the exposure surface. U.S. Pat. Nos. 6,190,016; 6,061,138; and 5,934,780 and patent disclosures EP 1 020 739 A2 and EP 1 172 684 disclose exposure apparatus that employ collimating optics in the path of the exposure beam. Collimated light is particularly advantageous when using conventional Brewster plate polarizers. However, this adds expense and is difficult to achieve, particularly for large-scale irradiation, since ideal collimation is feasible only when using a very small light source. Moreover, collimated light is not necessary for proper alignment processing. As is stated above, the goal is to provide polarized UV irradiation having sufficient intensity, wherein the light is spatially uniform over the sensitized surface area. Of itself, collimation does not correct spatial non-uniformity.

Thus, it can be seen that there is a need for an improved apparatus and method for applying a uniform, high-intensity UV exposure energy to a sensitized surface, particularly for large-scale surfaces.

### SUMMARY OF THE INVENTION

It is an object of the present invention to provide an apparatus and method for uniform irradiation of a substrate at large scale, which would be useful for preparation of an alignment layer in LCD fabrication. With the above object in mind, the present invention provides an apparatus for uniform irradiation of a substrate, comprising:

(a) a light source for providing source radiation;

(b) a uniformizing component for homogenizing the source radiation to provide a uniform exposure beam having uniform energy across the field;

(c) a polarizer for conditioning the uniform exposure beam to provide a polarized uniform exposure beam; and

(d) a telecentric projection system for projecting the polarized uniform exposure beam onto the substrate.

It is a feature of the present invention that it provides a projection system for providing high-intensity radiation in telecentric form.

It is an advantage of the present invention that it allows the intensity of illumination to be scaled appropriately for the surface area to be exposed. Additional intensity can be provided by increasing the number of light sources, without the need to increase the overall size of the apparatus.

It is a further advantage of the present invention that it allows flexibility in adapting the apparatus to accommodate the size and angular orientation of the surface to be irradiated.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram showing an exposure apparatus of the present invention;

FIG. 2 is a block diagram showing key optical components in the illumination path of the exposure apparatus;

FIGS. 3a-3d show, in perspective views, alternate arrangements of integrating components for one, three, and six light sources;

FIG. 4 is a block diagram showing an alternate embodiment for an integrating bar used as a uniformizer;

FIG. 5 is a block diagram showing an alternate arrangement of the apparatus of the present invention, with a polarizer disposed ahead of projection optics;

FIG. 6 is a block diagram showing an alternate arrangement of the apparatus of the present invention with a polarizer disposed proximate to the surface being irradiated;

FIG. 7 is a block diagram showing an alternate arrangement of the apparatus of the present invention with a Brewster plate polarizer disposed proximate to the surface being irradiated;

FIG. 8 is a block diagram showing how the projection apparatus of the present invention allows angular adjustment of the incident angle;

FIG. 9 is a block diagram showing an alternate arrangement of projection optics without a curved mirror; and

FIG. 10 is a block diagram showing an arrangement of optical components for increasing brightness by utilizing both orthogonal polarization components of the source light.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

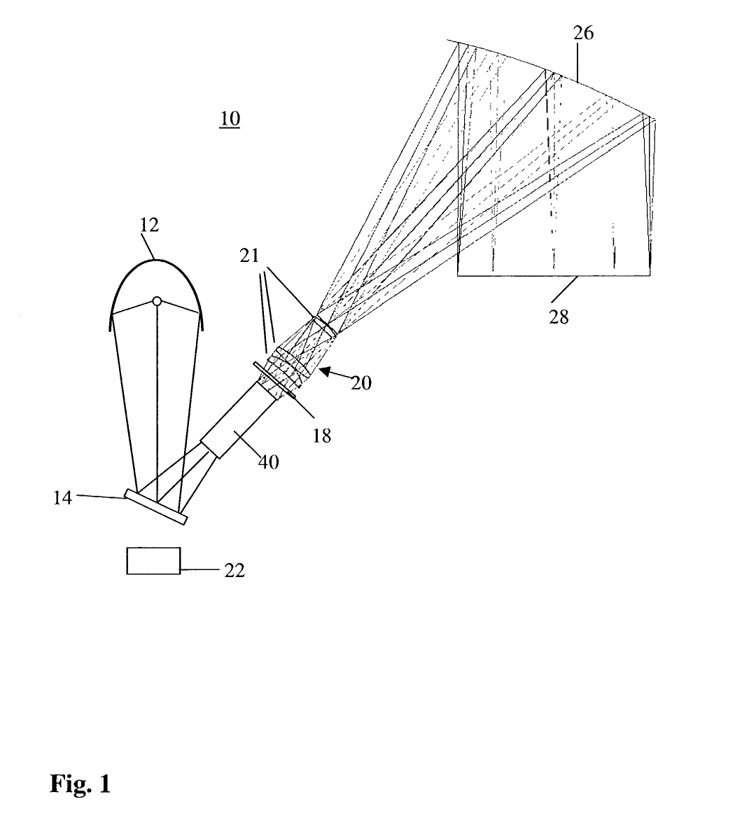

Referring to FIG. 1, there is shown an exposure apparatus 10 for irradiating a sensitized substrate at a surface 28. A light source 12 provides source illumination which is directed by a mirror 14, a dichroic UV-B reflecting mirror in the preferred embodiment, to an integrator 40. Integrator 40 acts as a uniformizer, homogenizing the incoming light to provide uniform intensity across the field. The homogenized or uniformized light is then directed through a telecentric projection lens 20, comprising a set of lenses 21, a three-element fused silica lens in a preferred embodiment, and a mirror 26. In a preferred embodiment, mirror 26 is spherically curved. Telecentric illumination is thereby directed onto the sensitized substrate at surface 28. A heat sink 22 is provided for dissipating heat transmitted through mirror 14.

Surface 28 has a defined area for exposure of the sensitized substrate. In a preferred embodiment, a sensitized substrate is controllably drawn through surface 28 at a fixed speed, allowing a complete roll of sensitized medium to be exposed in a continuous fashion, for example.

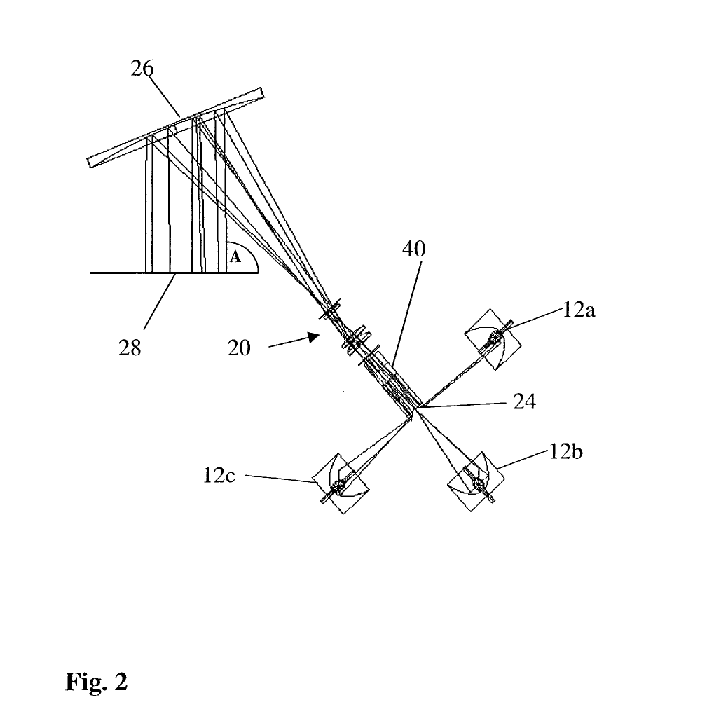

In a preferred embodiment, where exposure apparatus 10 provides high-intensity UV irradiation at surface 28, light source 12 is a high-intensity 8KW UV lamp. Where the area of surface 28 requires more intensity that a single lamp can provide, light source 12 may comprise one or more individual lamps, as shown in FIG. 2, where an optical combiner 24 is used to combine the illumination energy from light sources 12a, 12b, and 12c.

Optical combiner 24 could be a dichroic combiner, as is well known in the imaging arts. However, the present invention provides a more robust alternative as optical combiner 24, as is described below.

Configurations of Integrator 40

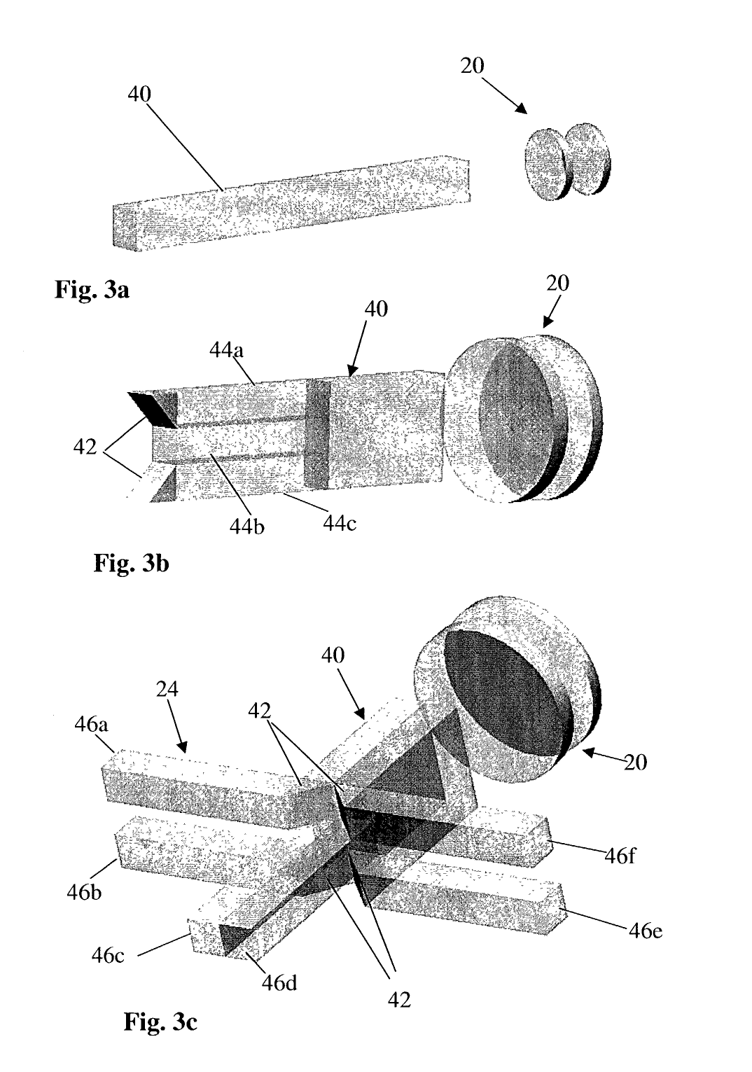

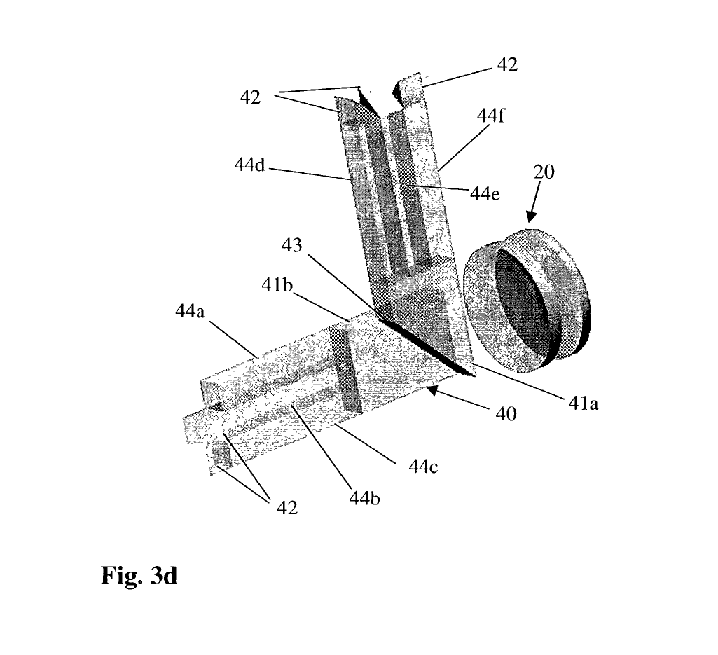

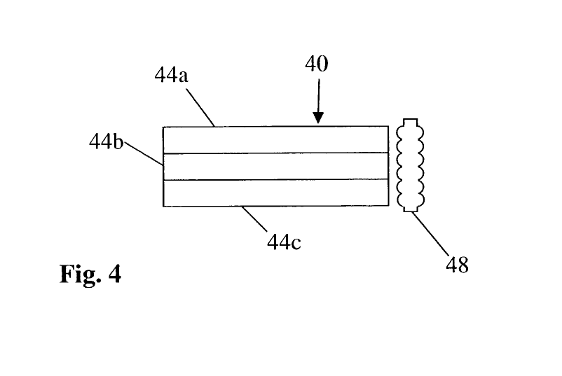

In its simplest configuration, integrator 40 is an integrator bar that provides homogenized light to projection lens 20, as is shown in FIG. 3a. However, where there is more than one light source 12, integrator 40 may perform both uniformizing and combining functions, such as in the arrangements shown in FIGS. 3b, 3c, and 3d. Referring to FIG. 3b, there is shown a configuration allowing integrator 40 to combine light from as many as three light sources 12. Combining structures 42 act as prisms, directing light into light channels 44a and 44c. With respect to the orientation of FIG. 3b, light sources 12 are provided from above and below integrator 40. A third light source 12 directs light into integrator 40 through light channel 44b. Referring to FIG. 4, light channels 44a, 44b, and 44c are then combined by a uniformizer element 48, which may be an integrator bar or may be some other type of uniformizing component, such as a lenslet array, for example.

Referring to FIG. 3c, there is shown an arrangement that allows integrator 40 to combine light from as many as six separate light sources 12. As in the arrangement of FIG. 3b, the FIG. 3c arrangement uses light channels 46a, 46b, 46c, 46d, 46e, and 46f to direct light into the integrating bar of integrator 40. Combining structures 42 are provided for light channels 46a, 46b, 46e, and 46f as shown.

Referring to FIG. 3d, there is shown an alternate arrangement by which integrator 40 can combine light from up to six separate light sources 12. Combining structures 42 allow light from left and right sides to enter light channels 44b and 44c. Light channel 44a allows a light source 12 to be positioned directly behind projection lens 20. Vertical light channels 44d, 44e, and 44f include combining structures 42 that allow additional light sources 12 to the rear and sides of projection lens 20. Segments 41a and 41b combine the light from each set of light channels 44a, 44b, 44c and 44d, 44e, 44f A diagonal surface 43 on segment 41a changes the direction of light from light channels 44d, 44e, and 44f as needed for alignment along the projection path.

Options for Polarizer 18 Configuration

Due to the high intensity of light energy used for irradiation applications, conventional sheet polarizers are not suited for use as polarizer 18 in exposure apparatus 10. Conventional Brewster plate devices have good thermal properties, but may not be optimal due to size, cost, and performance characteristics.

In a preferred embodiment, polarizer 18 is a wire-grid polarizer such as devices manufactured by Moxtek Inc. of Orem, Utah or described in U.S. Pat. No. 6,122,103, for example. Wire-grid polarizers exhibit high extinction ratios and high efficiency. These devices have good thermal performance and do not exhibit the thermal stress birefringence that is characteristic of glass-based polarization devices. Wire-grid polarizers have been shown to be able to withstand harsh conditions of light intensity, temperature, and vibration and provide a higher numerical aperture than is available using conventional glass polarization beamsplitters. This allows relatively higher levels of light throughput when compared against conventional polarization devices.

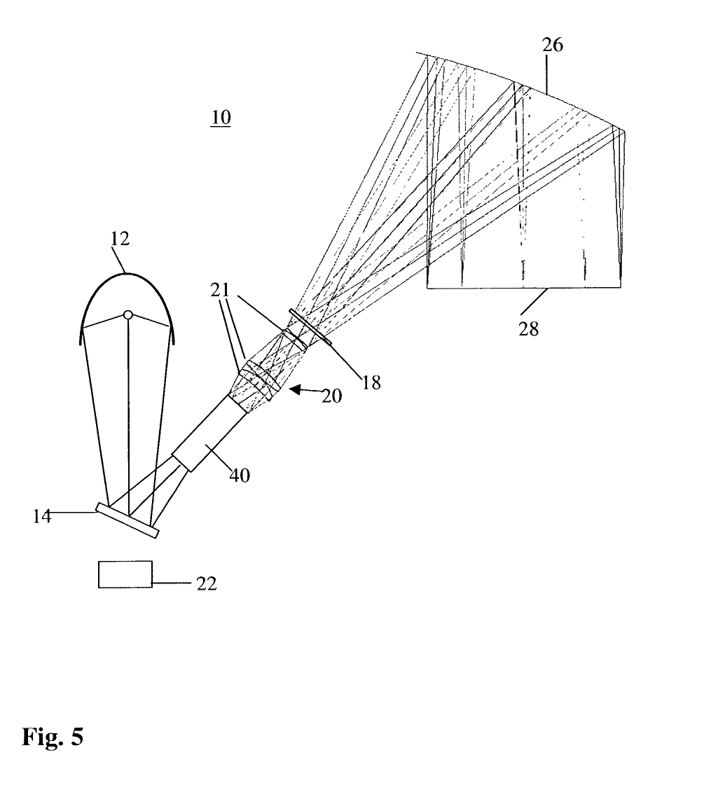

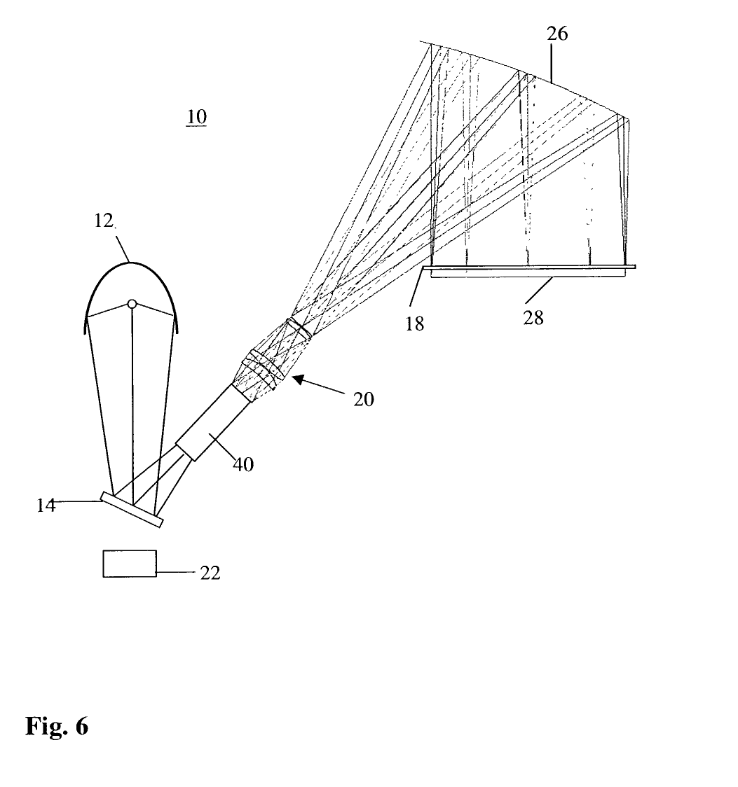

Wire grid polarizers offer particular advantages since these devices have a relatively low dimensional profile, allowing their placement at a number of suitable points along the exposure illumination path. Referring back to FIG. 1, polarizer 18 is positioned just after integrator 40 in the exposure illumination path, polarizing the uniformized light before it is incident to projection lens 20. Alternately, polarizer 18 could be disposed within projection lens 20. Referring to FIG. 5, there is shown an alternate arrangement, with polarizer 18 positioned before curved mirror 26 within telecentric projection lens 20. Yet another alternate arrangement would use a large polarizer 18 positioned just above surface 28, as is shown in FIG. 6.

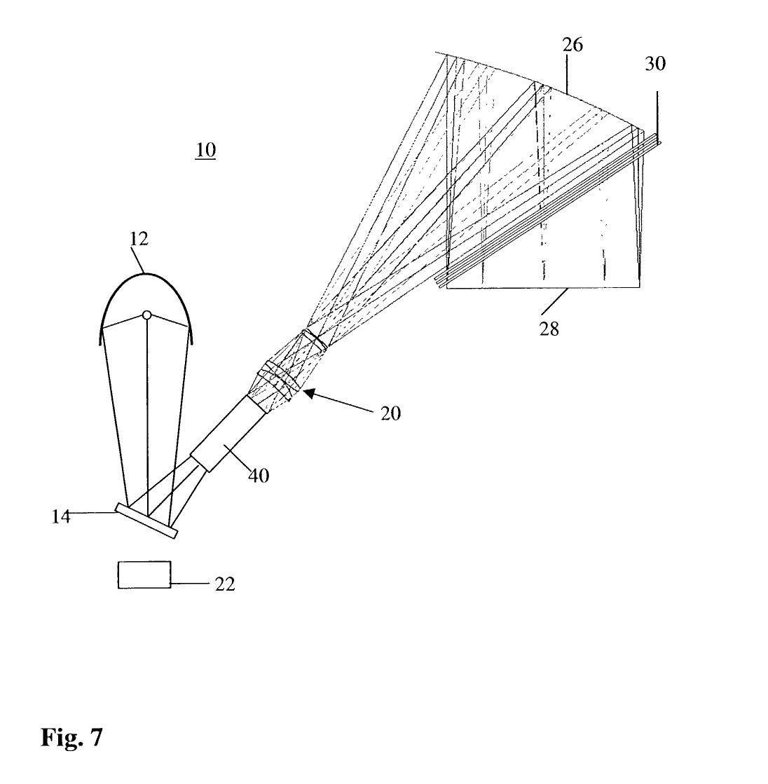

A less desirable option that can be implemented is shown in FIG. 7. Here, a Brewster plate polarizer 30 is used instead of a wire-grid polarizer. Due to size, weight, and maintenance constraints, the arrangement of FIG. 7 is generally less than optimal for delivering uniform polarized UV radiation over a large area to surface 28, however.

Polarizer 18 can be made to be rotatable about the optic axis. This feature could be used to allow the same exposure apparatus 10 to irradiate at different polarizations, for example.

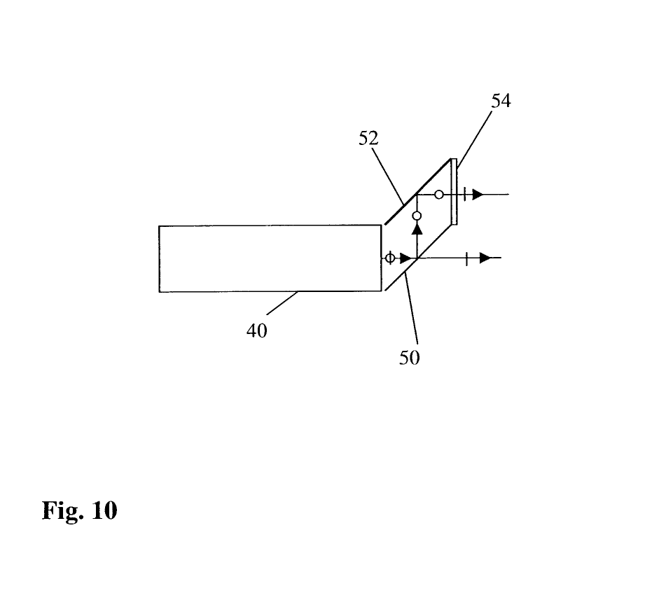

One inherent problem with polarization relates loss of light energy. Polarization effectively wastes half of the light that emerges from integrator 40. Referring to FIG. 10, there is shown one arrangement of components configured to re-use the polarized component of illumination that would otherwise be discarded. In FIG. 10, a circular symbol indicates s-polarized light, a short vertical line indicates p-polarized light, and a superimposed line and circle indicate non-polarized light. Non-polarized light emerges from integrator 40 and goes to a polarizing beamsplitter 50. P-polarized light is transmitted, s-polarized light is reflected by polarizing beamsplitter 50. S-polarized light would normally be discarded. However, a mirror 52 directs the s-polarized light through a quarter waveplate 54. Quarter waveplate 54 rotates the polarization of the incident s-polarized light to provide a p-polarized output. Thus, all of the light from integrator 40 is provided with p-polarization. It must be noted that the example of FIG. 10 assumes that p-polarized output is needed. With a slight rearrangement, moving quarter waveplate 54 into the path of p-polarized light transmitted through polarizing beamsplitter 50, the arrangement of FIG. 10 provides fully s-polarized light. Alternately, polarizing beamsplitter 50 could transmit p-polarized light and reflect s-polarized light.

Telecentric Irradiation

Conventional UV irradiation systems, as described above, provide collimated light to the sensitized substrate. As was noted above, the Brewster plate polarizer, sensitive to slight angular variations, works best with substantially collimated light. However, many types of sensitized substrate do not require collimated light. Instead, it has been found to be sufficient to provide uniformized light over a small range of incident angles. For this reason, the approach of the present invention is to provide, using projection lens 20, telecentric, rather than collimated, illumination. With collimated illumination, all rays are parallel. With uniform telecentric illumination, on the other hand, principal rays across the field are parallel but marginal rays converge at the image plane so that, looking back toward the projection optics, each point on the image plane effectively sees the same convergent light cone. Telecentric imaging is widely used, for example, in machine vision applications where it minimizes perspective distortion error. Mirror 26, preferably a spherical section mirror, projects the telecentric light onto surface 28.

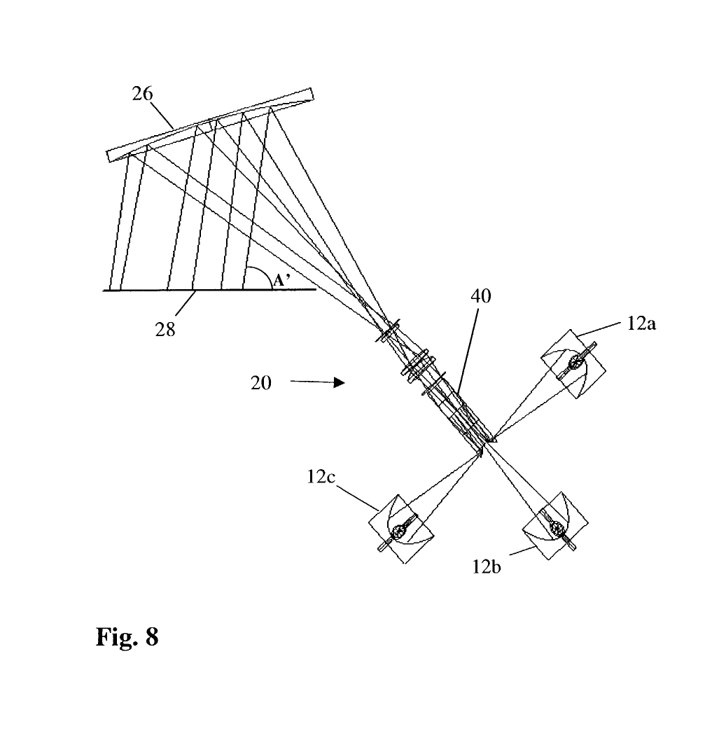

Mirror 26 could be provided with tilt arrangement hardware in order to adjust the angle of the exposure beam incident on surface 28. Comparing incident angle A in FIG. 2 with incident angle A′ in FIG. 8, it can be seen that a slight change in the angular orientation of mirror 26 can affect the incident angle of the exposure beam.

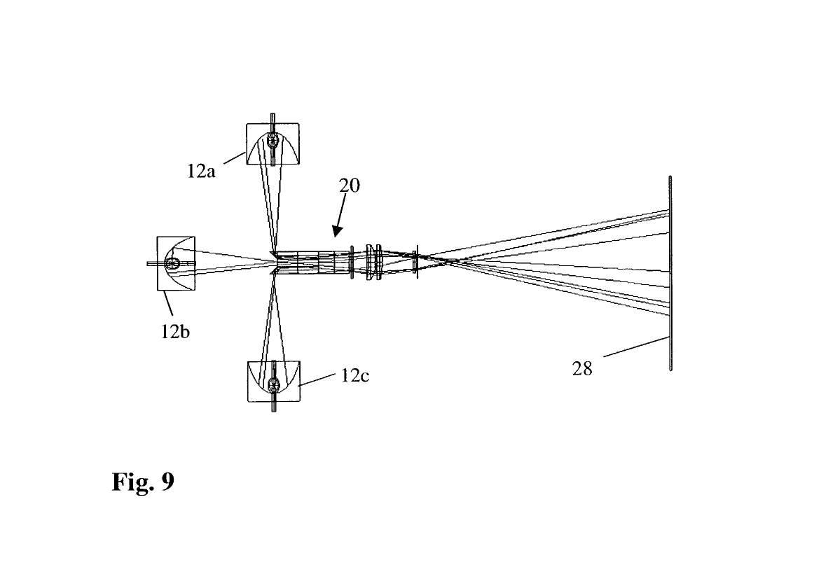

Referring to FIG. 9, projection lens 20 could be implemented without mirror 26, in order to project illumination directly onto surface 28. Note, however, that the light would not be telecentric; the incident angle of the irradiation would not be uniform across surface 28. This configuration could be used where uniformity of incident angle is not a requirement.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, polarization can be provided at a number of different points along the illumination path. A number of different types of light sources can be used, depending on the exposure intensity needed. Other supporting optical components could be added for further conditioning the illumination beam. Thus, what is provided is an apparatus and method for applying a high-intensity, uniform polarized irradiation onto a sensitized substrate.

### Parts List

10. Exposure apparatus

12. Light source

12a. Light source

12b. Light source

12c. Light source

14. Mirror

18. Polarizer

20. Projection lens

21. Lenses

22. Heat sink

24. Optical combiner

26. Mirror

28. Surface

30. Brewster plate polarizer

40. Integrator

41a. Segment

41b. Segment

42. Combining structure

43. Diagonal surface

44a. Light channel

44b. Light channel

44c. Light channel

46a. Light channel

46b. Light channel

46c. Light channel

46d. Light channel

46e. Light channel

46f. Light channel

48. Uniformizer element

50. Polarizing beamsplitter

52. Mirror

54. Quarter waveplate

What is claimed is:

1. An apparatus for uniform irradiation of a substrate, comprising:
(a) a light source for providing source radiation;
(b) a uniformizing component for homogenizing said source radiation to provide a uniform exposure beam having uniform energy across the field;
(c) a polarizer for conditioning said uniform exposure beam to provide a polarized uniform exposure beam; and
(d) a telecentric projection system for projecting said polarized uniform exposure beam onto the substrate.

2. An apparatus for irradiating a substrate according to claim 1 wherein said light source provides UV light.

3. An apparatus for irradiating a substrate according to claim 1 wherein said light source comprises:
(a) at least two lamps; and
(b) an optical combiner for combining light from said at least two lamps to provide said source radiation.

4. An apparatus for irradiating a substrate according to claim 3 wherein an integrating bar acts as said optical combiner.

5. An apparatus for irradiating a substrate according to claim 1 wherein said light source further comprises a heat sink.

6. An apparatus for irradiating a substrate according to claim 1 wherein said uniformizing component comprises an integrating bar.

7. An apparatus for irradiating a substrate according to claim 1 wherein said uniformizing component comprises a lenslet array.

8. An apparatus for irradiating a substrate according to claim 1 wherein said polarizer comprises a wire-grid polarizer.

9. An apparatus for irradiating a substrate according to claim 1 wherein said polarizer can be rotated to change the angle of polarization on said substrate.

10. An apparatus for irradiating a substrate according to claim 1 wherein said polarizer comprises a Brewster plate polarizer.

11. An apparatus for irradiating a substrate according to claim 3 wherein said optical combiner is a dichroic combiner.

12. An apparatus for irradiating a substrate according to claim 1 further comprising a mirror for directing said polarized uniform exposure beam toward said substrate.

13. An apparatus for irradiating a substrate according to claim 12 wherein said mirror is a substantially spherical segment.

14. An apparatus for irradiating a substrate according to claim 12 wherein said mirror allows a tilt adjustment for changing the incident angle of said polarized uniform exposure beam.

15. An apparatus for irradiating a substrate according to claim 3 wherein the number of said at least two lamps is determined by the area of the substrate to be irradiated at one time.

16. An apparatus for irradiating a substrate according to claim 1 wherein said substrate is an alignment material for liquid-crystal device fabrication.

17. An apparatus for irradiating a substrate according to claim 1 wherein said substrate is moved over an exposure area.

18. An apparatus for irradiating a substrate according to claim 1 wherein said polarizer comprises a polarizing beamsplitter for transmitting light of a first polarization and reflecting light of a second polarization.

19. An apparatus for irradiating a substrate according to claim 18 wherein said polarizer further comprises a waveplate for rotating the polarization state of said first polarization.

20. An apparatus for irradiating a substrate according to claim 18 wherein said polarizer further comprises a waveplate for rotating the polarization state of said second polarization.

21. An apparatus for uniform irradiation of a substrate comprising:
(a) a light source for providing source radiation;
(b) a uniformizing component for homogenizing said source radiation to provide a uniform exposure beam;
(c) a telecentric projection system for projecting said uniform exposure beam toward said substrate; and
(d) a polarizer for conditioning said uniform exposure beam to provide a polarized uniform exposure beam.

22. An apparatus for uniform irradiation of a substrate according to claim 21 wherein said polarizer is disposed near said substrate.

23. An apparatus for uniform irradiation of a substrate comprising:
(a) a light source for providing source radiation;
(b) a uniformizing component for homogenizing said source radiation to provide a uniform exposure beam having uniform energy; and
(c) a telecentric projection system comprising a polarizer for conditioning said uniform exposure beam to provide a polarized uniform exposure beam, said telecentric projection system projecting said polarized uniform exposure beam onto said substrate.

24. An apparatus for uniform irradiation of a substrate according to claim 23 wherein said uniformizing component provides homogenized light from a plurality of light sources, said uniformizing component comprising:
(a) for each light source, a light channel for directing light into said uniformizing component; and
(b) at least one prism structure for turning light into said uniformizing component.

25. An apparatus for uniform irradiation of a substrate comprising:
(a) means for providing source radiation;
(b) means for homogenizing said source radiation to provide spatially uniform energy;
(c) means for polarizing said source radiation; and
(d) means for telecentric projection of said source radiation onto said substrate.

26. A method for irradiating a sensitized surface comprising:
(a) providing a source radiation beam;
(b) uniformizing said source radiation beam to provide a uniform exposure beam;
(c) polarizing said uniform exposure beam to provide a polarized uniform exposure beam; and
(d) projecting said uniform exposure beam as a telecentric exposure beam.

27. A method for irradiating a sensitized surface according to claim 26 wherein the step of providing a source radiation beam comprises the step of combining light from at least two lamps.

28. A method for irradiating a sensitized surface according to claim 26 wherein the step of uniformizing said source radiation beam comprises the step of directing said source radiation beam through an integrating bar.

29. A method for irradiating a sensitized surface according to claim 26 wherein the step of polarizing comprises the step of directing said uniform exposure beam through a wire grid polarizer.

30. A method for irradiating a sensitized surface according to claim 26 wherein the step of projecting further comprises the step of reflecting said telecentric exposure beam from a reflective surface.

31. A method for irradiating a sensitized surface according to claim 30 wherein said reflective surface is curved.

32. A method for irradiating a sensitized surface according to claim 26 wherein said source radiation beam provides ultraviolet light.

33. A method for irradiating a sensitized surface comprising:
(a) providing a source radiation beam;
(b) uniformizing said source radiation beam to provide a uniform exposure beam;
(c) polarizing said uniform exposure beam with a polarizer rotated to a first position to provide a polarized uniform exposure beam having a first polarization;
(d) projecting said uniform exposure beam having said first polarization as a telecentric exposure beam;
(e) polarizing said uniform exposure beam with a polarizer rotated to a second position to provide a polarized uniform exposure beam having a second polarization; and
(f) projecting said uniform exposure beam having said second polarization as a telecentric exposure beam.
